(19) United States
(12) Patent Application Publication
(10) Pub. No.: US 2014/0168427 A1
(43) Pub. Date: Jun. 19, 2014

(54) NOTIFY ASSOCIATES OF CLEANUP JOBS

(71) Applicant: WAL-MART STORES, INC., Bentonville, AR (US)

(72) Inventors: Stuart Argue, Palo Alto, CA (US); Anthony Emile Marcar, San Francisco, CA (US)

(73) Assignee: Wal-Mart Stores, Inc., Bentonville, AR (US)

(21) Appl. No.: 13/718,955

(22) Filed: Dec. 18, 2012

(51) Int. Cl. G06K 9/00

(52) U.S. Cl. CPC G06K 9/00771
USPC 348/143; 382/103

(57) ABSTRACT

A process and method for identifying spills or other types of floor messes through computer-implemented image processing techniques are disclosed. Embodiments of the present disclosure include notifying cleanup tasks when such floor messes are identified. Image processing techniques may be employed to analyze images captured by surveillance cameras installed in a retail, commercial or industrial setting. Analyzed images may be forwarded to human operators for additional analysis or classification.

### BACKGROUND

Retail, commercial, and industrial establishments typically have an objective of keeping floors at their premises clean in order to maintain a perception of high quality and good service with customers and visitors. Unclean floors in factories, retail establishments, or other commercial or residential premises may create unsanitary and/or hazardous conditions to customers, employees, or visitors. Product spills or other floor messes commonly occur in retail grocery stores due to the high amount of shoppers and the nature of the products sold therein. For example, a retail grocery store inventory may include numerous liquid, gel, and like products. If the packing for such products is dropped and/or damaged, the product could leak and cause a floor mess. However, because of the size and number of aisles found in a typical grocery store, store associates may not notice the product spill within an optimal timeframe, in which case the floor mess may remain longer than is satisfactory. The perceptions of customers or visitors may be negatively affected by viewing a floor mess, and accordingly, any delay between creation of a floor mess and cleanup may be undesirable to the retail, commercial, or industrial establishments.

What is needed, therefore, is a cleanup notification system for identifying spills and other floor messes and notifying an associate regarding the mess.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a schematic block diagram of a cleanup notification system according to one embodiment;

FIG. 2 is a schematic block diagram of a cleanup notification system having a network-connected control center according to another embodiment;

FIG. 3 is a flowchart illustrating an exemplary method of identifying a floor mess and notifying an associate of a cleanup;

FIGS. 4A-4C are illustrations of graphical user interfaces displayed on a mobile computing device presenting cleanup notifications in accordance with various embodiments; and

FIGS. 5A-5B depict floor spaces under surveillance in a grocery store aisle according to embodiments of the present disclosure.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the spirit and scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flowchart and block diagrams in the attached figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

An objective of embodiments of the present disclosure is to automatically detect spills and other floor messes and alert a staff member or associate for cleanup of the mess. The detection of floor messes may be accomplished by using imaging processing techniques to analyze images and video captured by one or more cameras. Imaging processing techniques may be used to determine if any particular feature appearing in the video or images represents a spill or floor mess. Upon identification of any features in the videos or images that may represent a floor mess, a staff member or associate may be notified and given the location of the mess.

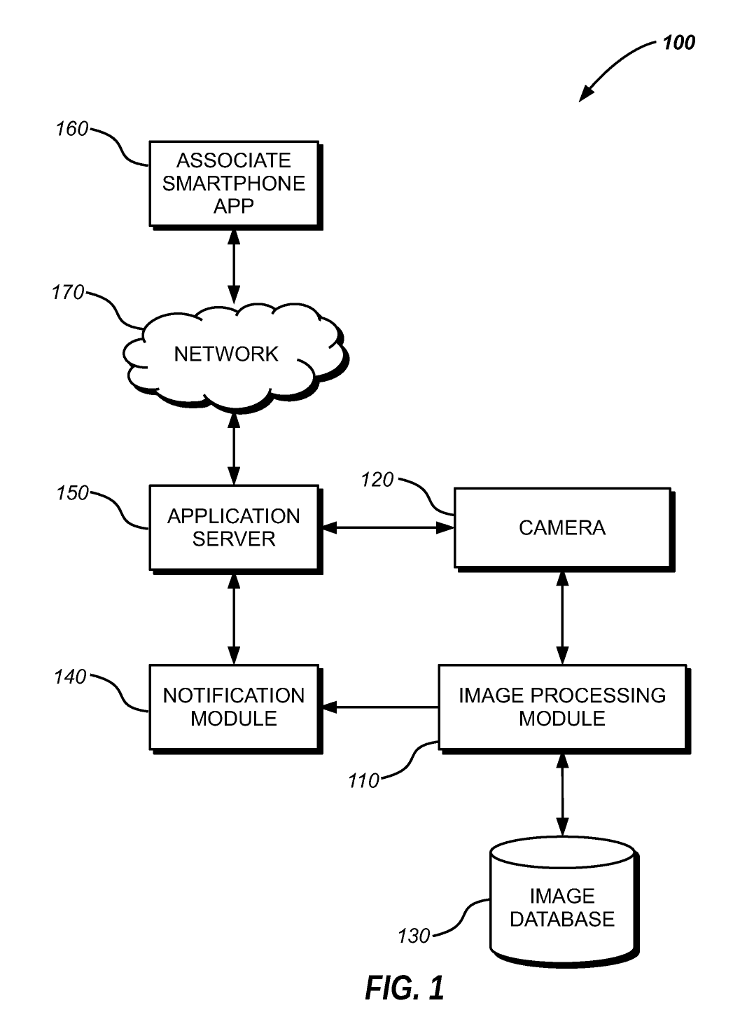

With reference to FIG. 1, an embodiment of a cleanup notification system 100 is disclosed. Cleanup notification system 100 comprises image processing module 110, camera 120, image database 130, notification module 140, application server 150, and associate smartphone app 160. Image processing module 110 is adapted to capture and compare images from camera 120. As will be described in more detail herein, an image comparison undertaken by image processing module 110 may generally include determining a reference image from multiple baseline images, comparing a test image to the reference image, and analyzing the differences between the two reference image and the test image using image processing techniques.

Image processing module 110 comprises software, hardware circuitry, or a combination thereof adapted to receive baseline images from one or more cameras 120 and from image database 130, use image processing techniques to compare baseline images with test images, and detect changes that correspond to a spill, a floor mess, or other situation where human intervention may be called for. The software and/or circuitry of image processing module 110 may be adapted to segment images into lines, pixels, blocks of lines, or blocks of pixels prior to conducting any comparison. Image processing module 110 may be adapted to query image database 130 for images. Further, image processing module 110 may be adapted to transmit instructions to camera 120, such as instructions that direct camera 120 to record video and/or one or more images at locations specified by image processing module 110.

In embodiments, camera 120 comprises multiple security or surveillance cameras, such as those typically installed on a ceiling or wall at retail, commercial, and industrial establishments. In other embodiments, camera 120 comprises other means capable of capturing still and/or video images of a target floor space. In embodiments, camera 120 is adapted to swivel, pan, and otherwise direct its image-capturing apparatus at various targeted locations in order to increase its view. Camera 120 is adapted to receive instructions from image processing module 110 or application server 140 for control of the orientation, direction, and/or zoom level of camera 120. In embodiments, camera 120 comprises a network of cameras that may fall under common control or otherwise coordinated direction, such that operation of the network of cameras may be coordinated to capture a target floor space from multiple angles.

In embodiments, camera 120 comprises a network of closed-circuit television (“CCTV”) cameras that transmit images into one or more central locations for conversion and/or processing. Camera 120 may capture images in analog form for later conversion to digital, or may capture images directly in a digital format, such as by a charge-coupled device (“CCD”) camera or other known digital image capture methods.

Image processing module 110 is adapted to transmit selected images to image database 130 for storage. As will be described in further detail, certain images may be stored at image database 130 and subsequently used as baseline images for comparison purposes. Image processing module 110 is adapted to selectively transmit queries for stored images from image database 130 when such images may be used in image comparisons.

In cases where image processing module 110 has detected a spill or other type of floor mess, image processing module 110 may transmit data related to its image comparison results to notification module 140. Notification module 140 is adapted to process data received from image processing module 110 and determine a course of action. If the notification module 140 determines that a cleanup is called for, notification module 140 transmits data related to the spill or floor mess, including any relevant image or portion of an image from camera 120 to application server 150. Application server 150 can transmit any such images to an associate's smartphone app 160 over network 170. Additionally, application server 150 can transmit instructions that cause the smartphone app 160 to display text directing an associate to take a specified action, such as investigation or cleanup. Application server 150 can also direct camera 120 to transmit additional images, which can be transmitted to associate smartphone app 160. Such additional images may be requested by an associate through the smartphone app 160 to application server 150.

In embodiments, associate smartphone app 160 may comprise computer-readable instructions stored in a memory device of a mobile computing device. The computer-readable instructions may direct the mobile computing device to accomplish numerous functions associated with the user's employment or similar duties with respect to a retail store or other premises. In addition to smartphone functions described herein, smartphone app 160 may provide additional functionality to the user. In embodiments, smartphone app 160 can allow a user to input additional commands, such as requests for additional information or images. In embodiments, a user can request additional images of a floor space as shown from additional angles. Such a request may be transmitted to application server 150, which transmits commands to camera 120 to capture and transmit the requested images.

In alternative embodiments, network 170 comprises any communication network including, but not limited to: a wireless network, a cellular network, an intranet, the Internet, or combinations thereof.

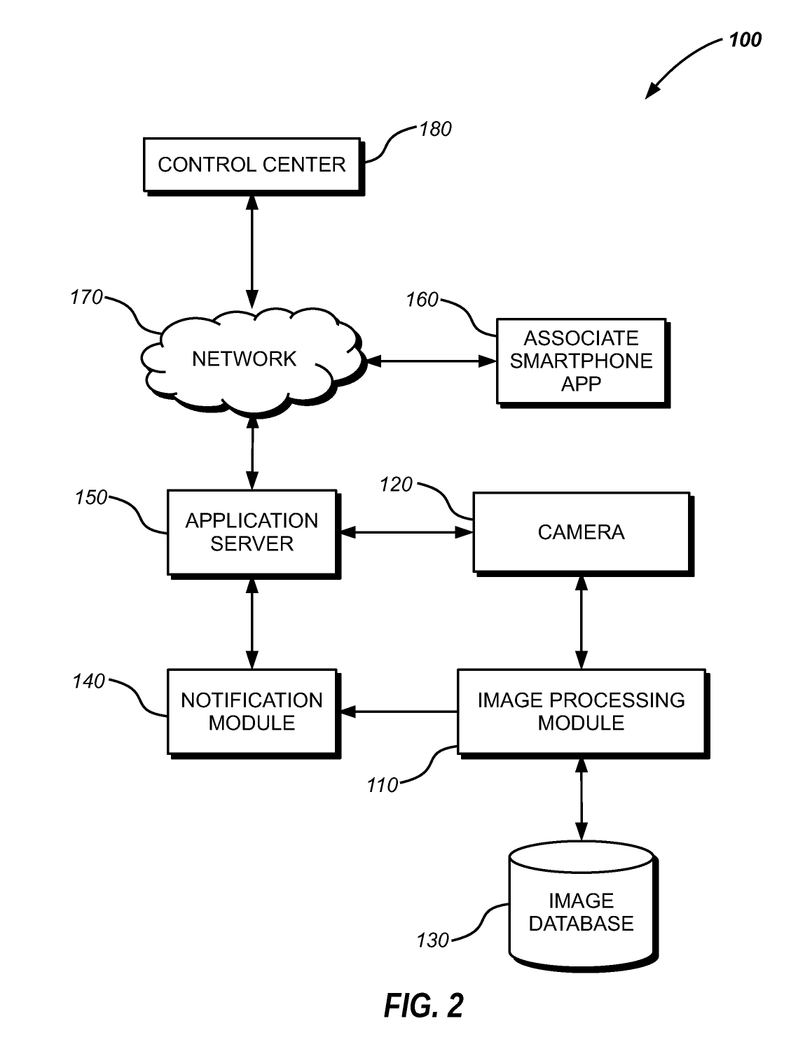

Referring now to FIG. 2, in one embodiment, application server 150 is adapted to transmit data regarding results from analyses conducted by image processing module 110 to control center 180. Such data may be transmitted through network 170. At control center 180, associates, who may be on-site or remote from the premises under surveillance, can observe images captured by camera 120 and/or flagged by image processing module 110. Control center 180 comprises one or more computer workstations by which associates may transmit computer-readable commands. Such commands may comprise a request for additional images or information. Alternatively, the commands may comprise a cleanup request.

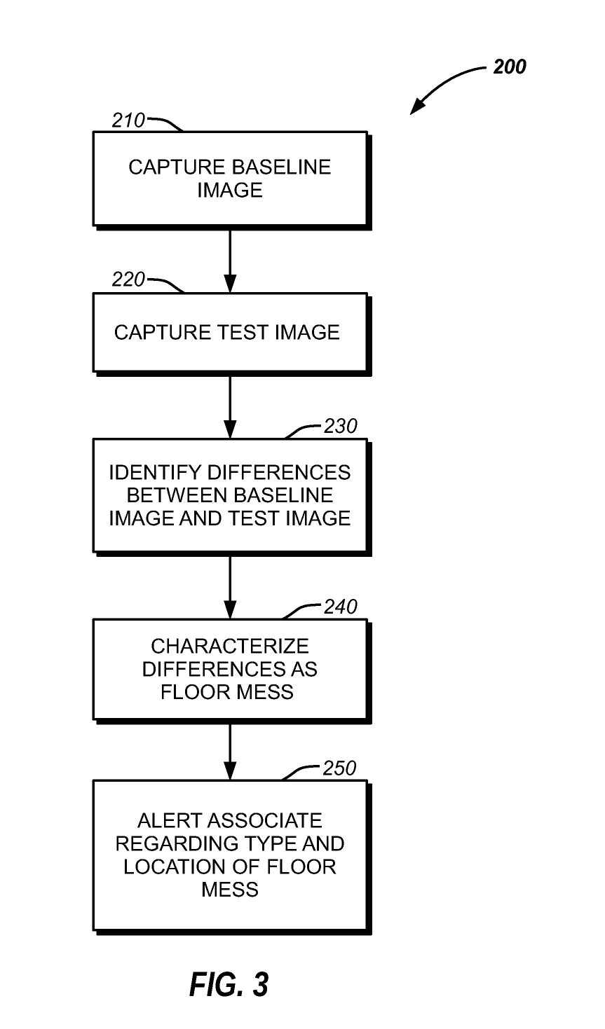

In operation, cleanup notification system 100 is adapted to identify product spills, floor messes, and other situations where a cleanup may be called for at retail stores, industrial premises, or other locations where such automated mess detection may be useful. Referring now to FIG. 3, embodiments of the present disclosure comprise method 200. At operation 210, camera 120 captures one or more baseline images. A baseline image may comprise a static representation of a floor space that is relatively clean and may be used as a frame of reference for comparison, as will be described in further detail.

At operation 220, camera 120 captures one or more test images. A test image comprises an image that may be analyzed to determine if it indicates any spill or other floor mess in the floor space depicted. Test images may be captured from multiple cameras 120 to represent the subject floor space from multiple angles and/or perspectives. Further, test images may be captured over spaced time intervals to portray whether any features in the images are static or dynamic.

At operation 230, image processing module 110 analyzes test images by comparing test images to baseline images and identifying any differences. The analysis may be accomplished by comparing the images on a pixel-by-pixel basis or image block-by-image block basis. Images may typically be compared to each other at the same or roughly similar orientation and zoom levels. The images may be compared using known image processing and analysis techniques. At operation 240, if differences were found between a baseline image and a test image, processing module 110 analyzes the test image to determine the nature of the difference. Additional test images may be captured by camera 120 for additional analysis. Image processing techniques may be used to determine if any particular feature of the test image comprises a person, a liquid spill, a solid object, dry product spill, liquid or solid waste material, or the like. Waste material may include human- or animal-produced waste including fecal matter, vomit, urine, and the like.

At operation 250, notification module 140 takes action appropriate for the results of the analysis conducted by image processing module 110. Potential choices of a course of action determined by notification module 140 may include: taking no action, notifying an on-site sanitation employee for cleanup measures, notifying an on-site associate for further investigation, and transmitting images and/or data to an on-site or off-site control center 180 for additional analysis. In an embodiment, notification module 140 alerts an in-store associate regarding the nature and location of the floor mess and directs the associate to investigate and/or clean the mess. In alternative embodiments, notification module 140 transmits a notification and related data to an associate at control center 180. The data may include the test image or additional images captured by camera 120 so that the associate at control center 180 can make an informed decision regarding an appropriate response.

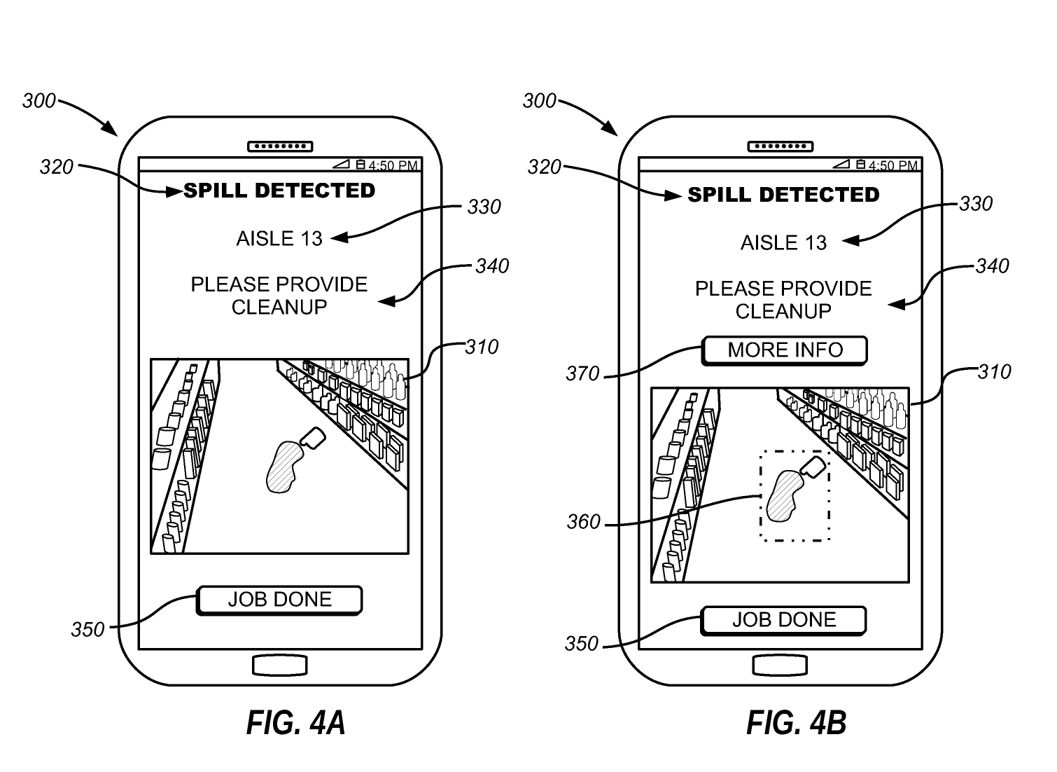

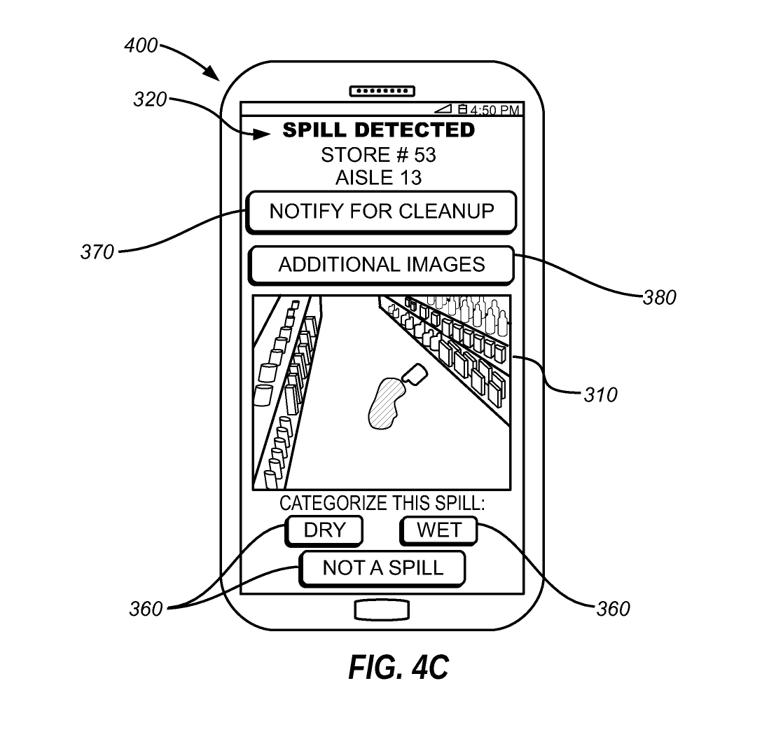

As depicted in FIG. 4A, a signal that is transmitted to smartphone app 160 may cause the associate's smartphone 300 to display an alert relevant to a cleanup notification. For example, smartphone 300 may display test image 310 captured by camera 120. Alternatively, image 310 may further comprise a relevant portion of the test image captured by camera 120. The displayed alert comprises an alert headline 320 that generally describes the alert condition. Location information 330 is displayed to direct the associate to a physical location of the detected spill or other floor mess. Instructions 340 may be included in the displayed alert to provide specific direction to the associate regarding any cleanup that is called for as a result of the detected floor mess. Job completion button 350 may be pressed by the associate upon completion of the cleanup task so that the open task may be closed. As depicted in FIG. 4B, in one embodiment, a highlighted marking 360 is displayed to direct the associate's attention to the detected floor mess to aid the associate in identification. Button 370 may be pressed by associate to request additional information and/or images related to the spill.

In some cases, image processing module 110 may be unable to classify a floor mess through automated image processing techniques. In such a case, an image may be transmitted to a person to view and classify the mess. As depicted in FIG. 4C, an image is displayed on smartphone 400. The user may be asked if the image depicts a floor mess and asked for a response by pressing one of buttons 360. The associate may be given an opportunity to identify the mess as a wet spill, a dry spill, or not a spill. Buttons 360 may be tailored for the specific types of spill that might occur in the setting where cleanup notification system 100 is utilized. In alternative embodiments, additional choices may be available to the associate. As depicted in FIG. 4C, the user may choose to instruct a sanitation associate to clean up the spill by selecting button 370. Alternatively, the user may request additional images, such as images from different angles, by selecting button 380. As would be understood by one of ordinary skill in the art having the benefit of this disclosure, the use interface depicted in FIGS. 4A, 4B, and 4C could be displayed on a tablet device, a desktop computer, or other computing devices. The user may be on-premises or may be remote from the premises, at control center 180.

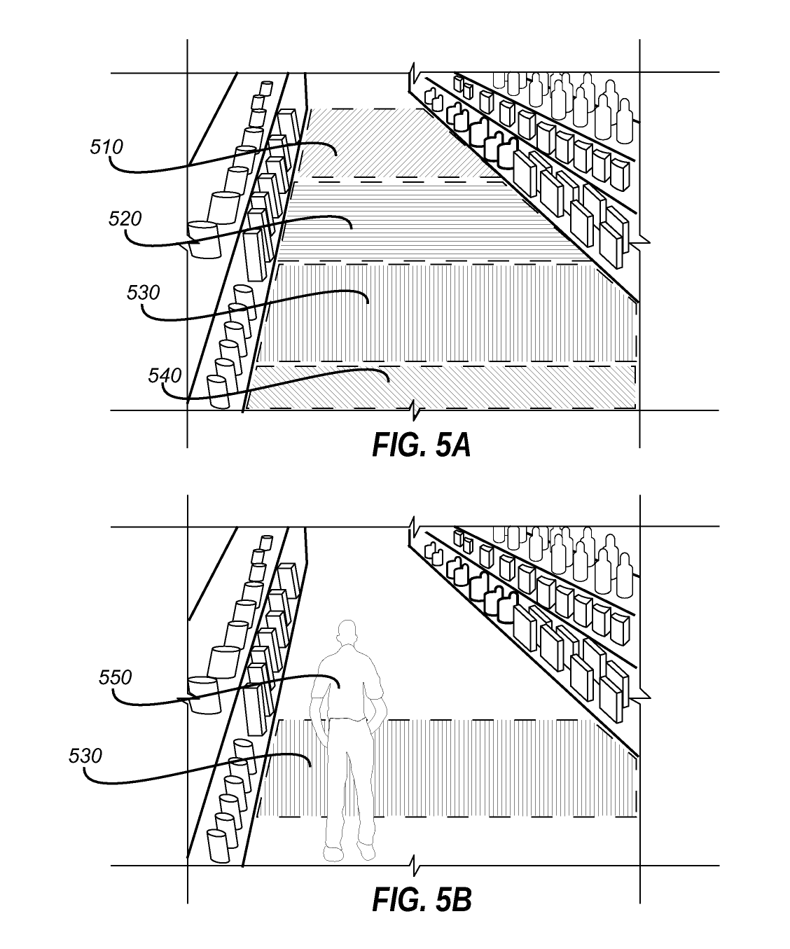

In embodiments, camera 120 captures multiple baseline images of a floor space at spaced intervals, which images are compared against each other to determine a reference image of the floor space. Referring now to FIG. 5A, floor space may be segmented into multiple floor space areas 510, 520, 530, 540. In embodiments, image processing module 110 is adapted to separately analyze each floor space area 510, 520, 530, 540. In analyzing multiple series of images depicting a floor space area 510, 520, 530, 540, image processing module 110 can identify a baseline appearance of a floor space and eliminate from consideration any objects or people that do not comprise a static component of the floor space. For example, camera 120 may capture five baseline images of floor space area 530 at random spaced times over the course of an hour. A comparison of the five captured images may show that one of the five images include image features that represent a person 550 or other object that happed to enter the field of view, as depicted in FIG. 5B. By eliminating from consideration such images that show such a person or object, image processing module 110 may determine a reference image of the floor space area 530. In a floor space with higher foot traffic, more baseline images may be captured to increase the probability that a sufficient number of baseline images will be analyzed that do not include non-static features therein.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the spirit and scope of the present disclosure.

What is claimed is:

1. A computer-implemented method of providing a cleanup notification, comprising:
capturing a reference image of a floor space;
capturing a test image of the floor space;
comparing the reference image with the test image;
identifying a feature on the test image as a floor mess; and
creating an alert regarding the floor mess.

2. The method of claim 1, wherein capturing a reference image of a floor space comprises:
capturing a first baseline image;
capturing a second baseline image;
comparing the first baseline image and the second baseline image; and
selecting one of the first baseline image and the second baseline image to be the reference image.

3. The method of claim 1, wherein capturing a reference image of a floor space comprises:
capturing a first baseline image;
capturing a second baseline image;
comparing the first baseline image and the second baseline image; and
forming a composite of the first baseline image and the second baseline image to be the reference image.

4. The method of claim 1, further comprising creating a graphical user interface adapted to:
display the test image and
allow a person to input a classification regarding the test image.

5. The method of claim 1, wherein creating an alert regarding the floor mess comprises transmitting a notification to a mobile computing device.

6. A system for providing a cleanup notification, comprising:
a camera;
an image processing module adapted to analyze an image captured by the camera;
an image database adapted to store the image;
a notification module adapted to create an alert regarding a result of an analysis conducted by the image processing module; and
an application server adapted to transmit a cleanup notification to a user.

7. The system of claim 6, wherein the image processing module is adapted to analyze a portion of the image corresponding to a target floor space.

8. The system of claim 6, wherein the image processing module is adapted to:
identify at least two baseline images and a test image and
compare a selected one of the baseline images with the test image.

9. The system of claim 6, further comprising a control center, wherein the control center comprises a display whereat a person may view the image.

10. The system of claim 6, wherein the application server is adapted to create a graphical user interface, wherein the graphical user interface is adapted to display the image.

11. The system of claim 10, wherein the graphical user interface is further adapted to allow a person to input a classification regarding the image.

12. The system of claim 6, wherein the camera comprises a surveillance camera.

13. A computer-implemented method of providing a cleanup notification, comprising:
analyzing at least two images of a floor space;
identifying a difference between the at least two images of the floor space;
transmitting a selected one image from the at least two images of the floor space to a first person;
receiving a classification regarding a condition of the floor space from the first person; and
notifying a second person of the classification regarding the condition of the floor space.

14. The method of claim 13, wherein notifying a second person of the classification regarding the condition of the floor space comprises transmitting instructions to the second person to clean up the floor space.

15. The method of claim 13, wherein analyzing at least two images of a floor space comprises:
comparing a first image and a second image and
determining if the second image comprises a static feature that does not appear in the first image.
